(19) United States
(12) Patent Application Publication
(10) Pub. No.: US 2019/0383260 A1
(43) Pub. Date: Dec. 19, 2019

(54) PNEUMATICALLY POWERED INTERNAL HYDRO-COMPRESSION ENGINE

(71) Applicant: CLARENCE EDWARD FRYE, BLOUNTVILLE, TN (US)

(72) Inventor: CLARENCE EDWARD FRYE, BLOUNTVILLE, TN (US)

(21) Appl. No.: 16/011,186

(22) Filed: Jun. 18, 2018

(51) Int. Cl. F03B 17/02; F01B 17/02

(52) U.S. Cl. CPC F03B 17/025; F01B 17/02

(57) ABSTRACT

This Hydrostatic/Hydro-Power engine's power to create energy arises from compression chambers filled by the force of Gravity to full capacity with water and is immediately ready to be instantly pressurized, amazingly enough, to virtually thousands of pounds (PSI). This uses an intensifier piston assembly pushing a small Force of compressed air against surfaces of water in the chambers. A computer program manages a repeating cycle of compression (PSI) and kinetic hydro-power bursts from chambers which collectively comprises a powerful hydro-power flow. This is by automated opening and closing of certain valves in connecting conduits. After/as pressurized water is expelled from a chamber, gravity almost instantly floods the vacant space again with enough water to reach full capacity, in reverse order the refilling water pushes the intensifier's piston upward in its cylinder, simultaneously ejecting the air from the piston's chamber space, thus the piston is reset to repeat another cycle.

### CROSS REFERENCE TO RELATED PROVISIONAL APPLICATIONS

62/528,261 3 Jul. 2017 Frye

### CROSS REFERENCE TO RELATED PATENT

U.S. Pat. No. 8,234,861 August 2012 Frye

### FEDERALLY SPONSORED RESEARCH RELATED APPLICATIONS

Not Applicable

### FOREIGN APPLICATION PRIORITY DATA

NONE

### FIELD OF INVENTION

This invention, a Hydrostatic/Hydro-Power engine, has 4 non-stroke events (intake, compress, power, exhaust), which is totally different from internal combustion engines as a power source. This engine uses the natural properties of water, added potential hydrostatic energy, as discovered by Pascal. Gravity fills pressure cells (compression chambers) to full capacity with water. High pressure levels may be created within this water (liquids) at held rest in closed containment. Pressures are changeable, being multiplied by using a solid body piston having large and smaller surface areas (aka. Intensifier). The system is powered by compressed air and managed by an automated computer management system which does timing of events just as the mechanical camshaft/ignition means does for a heat engine.

The system relies on a pressure multiplier to achieve high pressure levels in closed pressure cells, for afterwards release as kinetic energy bursts. The multiplier is placed as an intermediate device between the pneumatic and hydraulic segments of the system. The ends of the solid piston must have different cross-sectional diameters, one surface face area must be larger than the surface area of the other end. This ratio of areas number is a matter of designer choice for a particular work requirement. If the larger surface area would be sixteen times greater than the smaller area, then the pressure multiplication factor would increase by a factor of sixteen (16). Likewise, if the initial pressure on the piston surface was 100 PSI than the factored hydrostatic pressure cell would be 1600 PSI.

The object of this invention is two-fold: 1) to use low level air pressure to increase the pressure levels of static liquids held in an array of closed cells, (2) cells be refilled to capacity nearly instantly by natural force of gravity after its highly pressurized contents are released (expelled) as useable energy bursts. Its best use is providing hydro-power for electricity generation by being located in a body of water, moving or otherwise.

It might seem that the extra pressure is appearing out of nowhere, but this is not the case at all. It is resolved by an understanding that the areas of surface on the opposite ends of the solid piston are the compensating factor. The larger end is the pressure transfer (input) end and the smaller area is the output end. The principle is similar to using a lever to lift a heavy weight. The weight being an amount of water held in a closed cell, said water is comprised of molecules, and adding energy increases the amount of matter. When the energy is released, the mass goes back to what it was.

This invention is not a heat engine in which combustion generates the heat that takes place inside the engine proper. A heat engine's power is generated by the burning of gasoline, oil, or other fuel with air inside the engine. The hot gases produced is being used to drive pistons. There are one or more cylinders in which the combustion process takes place.

The heat process (chemical), utilizes a 4-stroke duty cycle (intake, compress, power, exhaust) to complete one operating cycle. The four movements or strokes of the piston occur before the engine firing sequence is repeated. A camshaft mechanically opens and closes valves in the cylinder head for each movement. The spark plug in each cylinder imitates the (power stroke) explosion by emitting an electrical spark into the compressed fuel mixture. The byproducts of combustion are harmful to the environment.

### BACKGROUND

### Prior Art

I am aware of certain prior art disclosures as follows:
[a] The three disclosures are: FIG. 4, Properties to be Pressurized; FIG. 4.1, Transmission of Pressure by Water; and FIG. 5; Pascal's Wine Barrel Experiment all of which are related, controlling principles applicable to my invention.
   [1] FIG. 4 is known as the hydrostatic paradox since it concludes that the pressure at a certain level in a fluid is proportional to the vertical distance to the surface of the liquid. Since the volume of fluid, in vessel A B C D, is at rest and not influenced by any external environmental workplace factors, it follows that the mass of fluid cannot put itself in motion (i.e. transform to kinetic). This state is INACTIVITY or INERTIA as used in mechanics. If it were capable of putting itself into a state of motion, ACTIVITY or INERTIA, it could nether change that motion (kinetic) nor return itself to rest (static). Any such change must be produced from/by some of the mass itself. In respect to system expansion capability, there are few practical limits for sizing of the volume capacity for liquid containment vessels or chambers of my invention, or the design variables responsible for the undiminished pressure bearing on the liquid held therein in a static state independent from workplace forces.
      [a] FIG. 4 and subset 4.1 is one of the forms under which the paradox is presented, i.e. the property of transmitting pressure equally and freely in every direction, is one in virtue of which a liquid becomes in reality a machine. It is no paradox, although so surprising and unexpected. A pressure of one pound exerted upon the square inch of surface forming the base of a piston will produce a pressure of one pound upon every square inch of the interior of the vessel containing the liquid. These are the common principles, as explained, governing the effects of mechanical force. The action is equivalent the forces acting on a lever having unequal arms in the ratio of 1 to 1,000. A weight of one pound acting on the longer arm of such a lever would support (static) or raise (kinetic) a weight of 1,000 pound acting on the shorter arm. The liquid, shown in FIGS. 2 and 3 at rest in containing chambers, performs the office of the lever, and the inner surface of the chamber containing it preforms the office of the fulcrum. There is nothing really paradoxical when understood. The theory for this effect is explained in some detail by paragraph [0028] subparagraphs (a1-a2 & a3). It results from molecular activity arising due to pressure applied external to a contained mass, the creation of energy.
   [2] FIG. 4.1 illustrates that liquids can take any form or shape, occupy any desired volume of space, large or small, and be pressurized to any pressure level by the force of gravity, as shown, or by application of mechanical pressure imposed on the surface of body of static water volume by an intensifier, that being a piston having a larger area end and a smaller area end. If a force of ten (10) pounds were applied to the larger piston end with a one (1) square inch area and the smaller end with a one quarter (¼) inch, the static pressure would be 160 (PSI) pounds per square inch. My invention is robust, these variables are design choices. The PSI can range in the thousands of pounds for pressurizing volumes of liquids held in a static state subject to controlled immediate release as a kinetic hydro energy force.
   [3] As related art U.S. Pat. No. 8,234,861 FREE FLOW HYDRO-POWERED HYDRAULIC RAM is in all respects a linear hydraulic motor which can perform all four-cycle engine functions simultaneously. Its centerpiece element is pistons within cylinders and a chamber with circuits, valves, etc. The pistons perform a long well-known art, the mechanical capability of intensifying of pressure levels between points A and B. FIGS. 6, 7, and 8 included herein are extracts from the patent showing the duty cycle of the Intensifier component which powers this linear hydraulic motor.
   [4] FIG. 5 illustrates that a wine barrel full water was increasingly pressurized as more water was added to the tube inserted into the barrel top with its column of water as a weight resting upon the water surface within the barrel. The structural integrity of the barrel failed when the water's pressure level exceeded its maximum stress limit. The barrel was destroyed and its water content burst outward into the external environment as a kinetic force. In contrast my invention provides for sequentially controlled energy bursts of hydro energy from its compression chambers (vessels). It follows that the structural integrity stress limits of all system components will by design exceed all resulting pressurization forces inherent in and bearing on the start-to-finish hydro production processes.

U.S. Pat. No. 8,627,658 McBride ‘SYSTEMS AND METHODS FOR ENERGY STORAGE AND RECOVERY USING RAPID ISOTHERMAL GAS EXPANSION AND COMPRESSION’ includes these principal properties which stand in direct contrast to properties of my invention.
[a] McBride's method and means Re: producing of compressed air are as follow:
   [1] Relies on a supply of excess electricity to compress air and store it efficiently at high pressure (3000 PSI) in multiple reservoirs, there is only so much space. This energy is held in reserve for later use to generate electricity when there is an immediate user demand for additional electricity. To satisfy the user's demand, the system uses the stored compressed air to power a hydraulic electricity generator. When the system's reservoirs are emptied of their air supply the system then waits for its next supply of excess electricity power so it can once more operate its air compression function and once more restock its reservoirs to full capacity with high pressure compressed air to await future user demand.
   [2] Just the opposite, independent suppliers using their air compressors, whomever they might be, furnish all the compressed air required to operate my system. So common that compressed air is almost a fourth utility because of its widespread industrial/consumer use. As shown in FIG. 1 an independently operated External Air Compressor is in direct communication via valve V2 with my COMPRESSED AIR CONTAINER, this being an accumulator containing low pressure, say 150 PSI. Compare this to McBride's electrical energy saving function (i.e. conversion to high pressure compressed air as storable energy, 3000 PSI. The intended use was much later, perhaps for the electrical power grid. My invention does not store compressed air, it operates and uses a pneumatic force to apply hydraulic intensifier assembly. McBride's storage mode is not relevant to my system. Furthermore, McBride's inclusion of a force multiplier element, for its air compression function, was well established mechanical engineering art known and widely practiced during the eighteenth century. It was known as an Intensifier of a Force (pressure). Reversing the travel direction of a piston's actuator ends in either a hydraulic or pneumatic cylinder, i.e. small area to large area, relative to a workload, resulted in the reduction (expanding) of pressure.
[b] McBride's means and methods Re: A hydraulic circuit driven electric generator motor to produce electricity is as follows:
   [1] The hydraulic circuit is powered by high pressure compressed air (3000 PSI) released from the system's multiple reservoirs, said compressed air having been stored earlier by a compression process powered by excess electricity being saved by storage for later use. In contrast, my invention has no involvement with start/stop constraints related to the realities of user demand which is out of synchronization with electricity generation availability cycles. My inventions hydro power energy flow is ready for immediate delivery whenever/wherever needed for electricity generating. Also, it is it is a generic prime mover for different end items. Its best use would be providing kinetic hydro power energy for either impulse or reaction turbines. One favors bulk volume low pressure flow, the other works with higher pressure levels. My invention can provide either as the case may be.
[c] In summary, McBride's system begins with activating a dual pump/generator motor that is powered by electricity, then saves its output as stored compressed air energy in reservoirs (accumulators). This stored energy is used to power hydraulically a generator to produce electricity subject to having sufficient stored air to draw from the accumulators. At all times these processes are encountering considerable opposing resistance within and normal to this unique workplace environment. Thus, while matter can be put into motion, kept in motion and then reach a designed mechanical result, be repeated as a duty cycle over and over again, it necessarily requires expenditures of energy from/by its external energy source. Matter cannot spontaneously move itself; it must be acted upon to change states. The kinetic energy forces, in all aspects of McBride's invention, to save electricity for later times and generate electricity, has its forward motions encounter and overcome any and all resistance present within its work environment.

McBride's compressed air hydraulic cylinder assembly has long been known Prior Art concepts, used and practiced in the field of fluid dynamics, i.e. intensifiers and accumulators, on the gas side of its compressed air storage example we have included as FIGS. 6, 7 and 8 extracts from U.S. Pat. No. 8,234,861 circuits. The Hydraulic Ram's power unit is a well-known commonly used Intensifier element, just as McBride. The fluid side circuits also use well known Prior Art to power a hydraulic generator of electricity. It is noted that my invention does not run afoul of McBride's means and methods. It is further noted the patent office records for McBride's patent includes these notations:
[a] Jan. 14, 2014 Issue Date
[b] Aug. 28, 2017 Maintenance Fee Reminder Mailed
[c] Patent Expired Due to Nonpayment of Maintenance Fee Under 37 CFR 1.362
[d] Feb. 12, 2018 Expire Patent

In contrast with McBride's means & methods, my invention applies a very small compressed air force via a multiplying mechanical force to a mass of liquid (water) resting in a static state, (FIG. 2 Internal Compressed Hydro Power Vessel or i.e. compression chamber). This elevated pressure being immediately present throughout the body mass the same way as by applying of a gravity force so demonstrated by Pascal's wine barrel experiment (FIG. 5 of Prior Art). This method avoids all encounters with load factors in the work environment. This is can be a far higher pressure level than the any level present in the external workplace environment. This pressure can be a controlled, released (Valve V2) as a controlled burst of kinetic energy, 2 valve V5, into a circuit being in communication with and as a supporting prime mover for a mechanical energy converter such as hydro powered turbine or similar powered apparatus. This is a single outward kinetic flow/replenishing inflow event of water. The pressurized water was expelled from the compression chamber, this immediately created some unoccupied space within the chamber, and this in turn triggered a replenishing flow from the body of water outside the chamber via the inward one-way valve VI, FIG. 2. This replenishment intake by restoring water to the full capacity of the chamber including its entry port way with pressure bearing on the surface area of the small end of the solid piston. In summary, my invention can sustain a continuous kinetic flow of energy. Furthermore, the system is robust and can readily be expanded to satisfy user demands of whatever volume or character whenever or wherever an acceptable economic basis for such arises. This is not the case for McBride's system as is evident, its purpose is very specialized in its entirety and too limited in overall scope for large scale expansion.

I am further aware of these disclosures of Prior Art;
[a] US 2012/0096845 Ingersoll “SYSTEMS AND METHODS FOR COMPRESSING AND/OR EXPANDING A GAS UTILIZING A BIDIRECTIONAL PISTON AND HYDRAULIC ACTUATOR”.
[b] US 2015/0176489 Ulrich “Unknown Title” (air compressor)
[c] US 2013/0340420 Blieske “SYSTEMS AND METHODS FOR OPTIMIZING THERMAL EFFICIENCY OF A COMPRESSED AIR ENERGY STORAGE SYSTEM”
[d] US 2014/0026549 Fong “UNKNOWN SUBJECT”
[e] U.S. Pat. No. 8,561,390 Nelson “ENERGY PRODUCTION SYSTEM USING COMBUSTION EXHAUST
[f] US 2013/0168961 Stahlkopf “COMPRESSED AIR ENERGY STORAGE SYSTEM UTILIZING TWO-PHASE FLOW TO FACILITATE HEAT EXCHANGE”

The only common feature the six (6) Prior Art devices, identified in paragraph (12) above is the storage of energy in a gaseous state and the improvement of the air compression processes. One is a combustion process to recover carbon dioxide from its own exhaust products. None of the citations disclose a hydrostatic-based-power-system or the features or the capabilities of this invention.

I am aware of the diamond anvil cell (DAC) as prior art technology developed by the National Bureau of Standards. The DAC is a high-pressure device used in scientific experiments. The pressure supplied by the DAC can be transformed into hydrostatic pressure. The cell's pressure transmitting medium is a compressible fluid. Hydrostatic pressure is the preferred medium for high pressure experiments. With this DAC embodiment, it is possible to achieve pressures of up to 7.7 million atmospheres.

My invention and the DAC rely on the very same principles of physics as natural laws, that is Pressure=Force Over Area. See FIG. 1, Force Multiplier.

### SUMMARY OF INVENTION

The invention is comprised of several cells (hydraulic segment) and (the pneumatic segment) intensifier piston cylinder. The two being independent of the other but co-joined as a unified mechanical system. The duty cycle is managed by a computer program module which is programmed for a 4 non-stroke duty cycle operation of an array of hydrostatic cells (chambers) operating in consort for delivery of kinetic energy. This automated plays the same role as the camshaft, valves and ignition elements do for the timing and performance of an internal combustion engine. A common mechanical/electrical/fuel operating system.

(a) The COMPUTER MANAGED SYNCHRONIZER MODULE, FIG. 3, as a management control system must include sequencing programs and instrumentation sufficient to operate and maintain the system, with full consideration and inclusion afforded the requirements of specific end item applications. In brief the system must be able to sense system conditions and sequence the movements of flows thru what comprises a total complex hydraulic circuit. The system of valves and pressure sensors as is shown in herein is necessarily rudimentary and illustrative in nature only, not restrictive. Valve V1 is a full flow check valve which responds to Gravity to begin/continue the movement of water into and thru the chambers, Valve V2 loads and maintains an adequate supply and pressure levels of elastic air energy to keep the system operating, Valve V3 releases the air needed by the Intensifier to impress such upon and hold such on the large piston area with small area end piston face pressed against the surface of water contained within a compression chamber until Valve V5 a, b, or c releases the mass from the chambers, Valve V4 immediately following a release by Valves V5 a, b, or c, opens and permits the air pressure present in the Intensifier's piston chamber to be vented to the free atmosphere, the releases by Valve V5 a, b or c converge and become one unity in motion and Valve V5 releases this pressurized flow as a prime mover, Valve V2 by refilling a chamber to full capacity also in doing resets the Intensifier's piston o make ready for the net cycle to begin once more, Valve V4 closes and is ready for Valve V3 to pressurize The Intensifier's piston chamber. All valves except Valve V2 (check valve) are solenoid controlled and activated to open or close by the synchronizer function, module and valves all being in communication and responsive to conditions as the process proceeds forward in the repetitive routine. All solenoid valves open in response to automated command, otherwise they are closed.

The system as shown resides partially submerged in a body of water. The water flows into an array of pressure cells, pressurized by a pressure multiplier, and then released in sequential order from the several cells as a unified kinetic energy flow. After doing beneficial work, the spent water is discharged. The water has no physical changes in its physical properties from the compression process.

This invention, in size and scope, may be placed wherever there is a power source to provide compressed air (pneumatic), and sufficient water (hydraulic) to supply pressure cells with volumes in a static state of rest.

The energy output flow can be converted to mechanical energy or to support other purposes such as electricity generation or reverse osmosis process.

### DESCRIPTION OF THE SEVERAL VIEWS OF THE DRAWING

The drawings, FIGS. 1 and 2, are readily understood as the means and methods for using an external air compressor to pneumatically power a hydro internal compression engine. The system increases the pressure levels (PSI) of water volumes at rest in an array of closed cells. The contents are in a static state of rest, with a high potential PSI level. The releases thereafter, are comparable to emergency relief of overload pressurization in conventional cells and are energy bursts of hydro power. The key to establishing high static pressure levels (PSI) in a closed cell is by using a pressure multiplier powered by compressed air. FIGS. 4 subset 4.1 and 5 display/illustrate the natural properties of liquids discovered by Pascal, which are the principles in physics upon which this invention relies as natural laws.

The annotating terms used to describe features in FIGS. 1 through 3 are commonly used terms in plain text as indicators of purpose and are functional characteristics understood within the overall context of this invention. These are readily understood by practitioners skilled in the arts and knowledge of pneumatics and hydraulics (static and kinetic).

FIG. 1 is a flat plat conceptual representation of the system from top to bottom with abbreviated views comprised of:
[a] A computerized system that operates everything from the compressed air function to the release of energy bursts in a sequence, from multiple closed cells containing highly compressed volumes of water. Sensors placed throughout the system do the same thing that camshaft and ignition/timing systems do for a 4-stroke internal combustion engine. See FIG. 3, COMPUTER MANAGED SYNCHRONIZER MODULE.
[b] An external air compressor provides a continuous supply of low-pressure (PSI) by way of Valve V2 for an on-demand flow to a storage container. A Valve V3 releases compressed air to activate a piston function that compresses the water at rest in the closed cell.
[c] A pressure multiplier is the means to increase pressure levels in static volumes of water. The large area of the piston applies its total force of compressed air to the larger area which extends to the smaller area piston end touching the static water in a closed cell. This focused force is impressed upon the static water as the means to greatly increase pressure (PSI) levels in static volumes of water. The piston does minimal linear travel within its cylinder. It is simply a compression force only.
[d] The source of water to fill the pressure cells may be from any source; an off-site storage impoundment, moving streams or lakes, etc. A check valve V1 with an intake port are means of assuring the filling of cells to full capacity

FIG. 2 is a flat plat representation of the system from a top to bottom showing the functional parts of the system from compressed air source to discharge of spent water out of the system. It does not include the electronic management module, as in FIG. 1. It does indicate that the system requires an attachment to some point for both support and positional placement. FIG. 2 includes the following components:

Free Atmosphere and Water Level. As shown the system may be partially submerged either in an open water location or a contained reservoir, but this is a matter of choice. It only requires a water supply wherever found such be available. Above or submerged, it is necessary to have in all cases some access freedom to a free atmosphere so that compressed air pressures arising from the as pneumatic function can be properly vented outward following a Force application action.

External Air Compressor. The air compressor can operate from any power source; fossil fuel, electricity, wind, solar, moving water, etc. The air supply must be capable of continuously maintaining sufficient pressure levels in the storage tank. Valve V2 is used to assure that proper air into the pressure levels are maintained in the compressed air container by the air compressor. While not shown, the compressed air as the operative force, it could be replaced by a conventional hydraulic system. The air vent would then become a fluid return line for the hydraulic circuit. This would be a second embodiment of this invention, i.e., an equivalent force for multiplication by piston apparatus as shown in FIG. 1.

Compressed Air Container. The container stores a quantity of low pressure compressed air that supplies the force multiplier as described in FIG. 1. Valve V2 is closed, except when opened to input more air into the container. Valve V3 opens to release air as the force to operate the pneumatic piston movement in FIG. 1. The outward pointing arrows in the illustration indicate that air is an elastic force that must be restrained, lest it fly away.

Force Multiplier. This is the heart of (the equivalent of gravity) as it applies to my invention as in the wine barrel experiment by Pascal and his discovery of the properties of water as illustrated by FIG. 4. In contrast, FIG. 5 shows his wine barrel experiment as proof that a small force can overpressure the contents in any closed container and destroy its structure. This invention safely retains static high pressure held momentarily in cells for controlled releases of kinetic hydro flows to do beneficial work of sundry purposes.

Internal Compressed Hydro Power Cell. Each cell in this invention is filled, or being filled, to capacity from a water source that is continuously pressing on check Valve V1. Any less than full capacity causes the check valve to open and remain so until the cell is once fuller with contents in a static at rest state. The arrows indicate that even though water is non-elastic that as a liquid it presses in all directions as discovered by Pascal. Valve V5 opens to permit the high pressure to be expelled as kinetic energy bursts. It closes to permit refilling of the cell to full capacity.

Mechanical Energy Converter. A uniform flow of hydro power from an array of multiple cells is released by valve V6 for application to work purpose. This conversion may be to rotational torque or hydro power moving against a work object for sundry purposes, energy to do work. This involves multiple cells whose contents have been pressurized or are in the refilling to capacity phase prior to compression to high psi levels. The computer management module is opening/closing valves within the 4-movement duty cycle which culminates in releases in form of kinetic hydro power.

FIG. 3 shows the distribution and delivery of kinetic energy from an array of cells and the computer module. All functional parts of the system and details for understanding the duty cycle events have been clearly described by FIGS. 1 & 2 previously, or are described in further detail herein.

### DETAILED DESCRIPTION OF INVENTION

FIG. 1 is a flat plat conceptual representation of the system top to bottom abbreviated views;
[a] The principal parts of the system are (1) array of pressure cells, (2) an ample supply of water to fill almost instantly the cells to capacity, (3) a pneumatic means to greatly increase the pressure levels (PSI) in the cells and (4) a computerized management system that functions like the camshaft/ignition/timing of an internal combustion engine.
[b] The water, which is the medium for the high energy bursts enters an intake port via check valve V1 of each pressure cell. The water enters at the ambient pressure (PSI) level of the external supply source. If it were from an interior reservoir then it would be continuously recirculating as the water properties remain unchanged.
[c] An external air compressor furnishes compressed air by valve V2 into the container at a low pressure (PSI) for powering the compressing function of the system. The air is released by valve V3 to start the 4 non-stroke duty cycle in response to a computer valve opening command.
[d] Valve V4 is the vent line to the free atmosphere for vacating any compressed air remaining in the large piston area space after a release of energy by valve V5. This permits the piston to reset and makes space available for the next release by valve V3 to activate the piston to start a new compression-cycle.
[e] The force multiplier consists of a piston within a cylinder structure in communication with the water being at rest in the cell. The multiplication effect relies solely on the solid piston having different surface areas on its opposite ends. Surface Area B has only a fraction of the surface area of larger Area A surface. If area A was 1-inch square and B was one/quarter ¼ inch square then the fraction be 1/16th. If the low-pressure input on area A was 100-PSI then the compression force on the water at rest in the cell would be 1,600-PSI. It follows by Pascal's law (FIG. 4) that this pressure level of the contents would prevail irrespective of how large or small the cell's capacity. And, further the ratio could be further increased from pressure multiplication factor of 16 to much higher numbers.
[f] Changing the static PSI level in a cell would simply be a matter of air pressure PSI input in combination with piston surface area size on opposite ends. If the low pressure input only on area A was increased to 150 PSI then the compression force on the water at rest in the cell would be 2,400 PSI. For economy of effort, the volume of compressed air required per cycle for a cell would be minimal. The piston a moves very small linear travel distance within its cylinder, it is simply a constant compressing, touching force between equally forces balanced opposing surfaces.

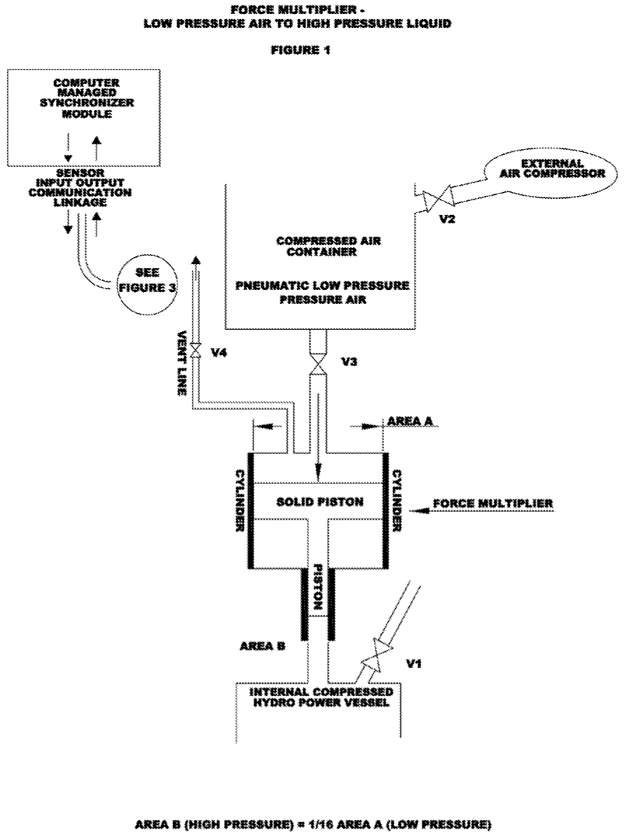

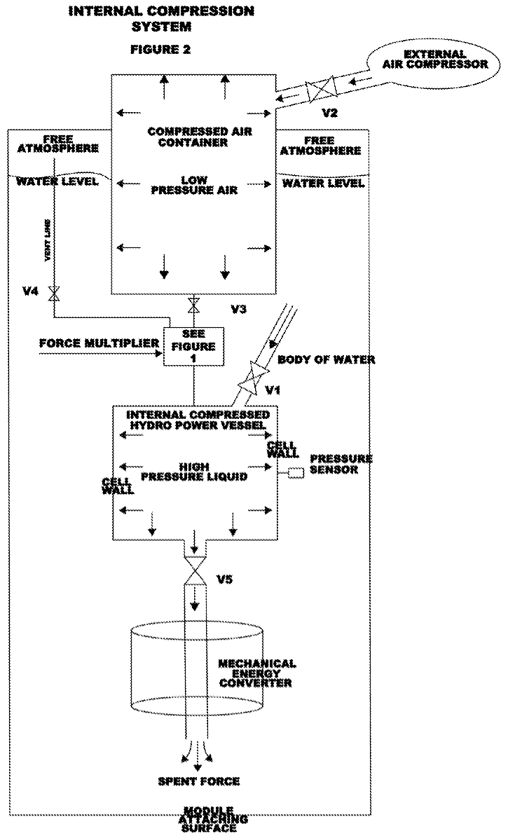

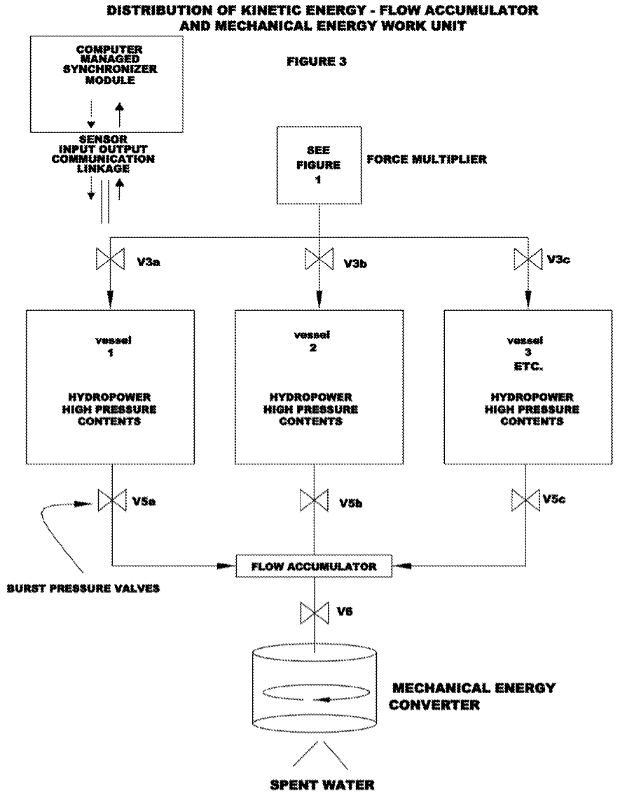

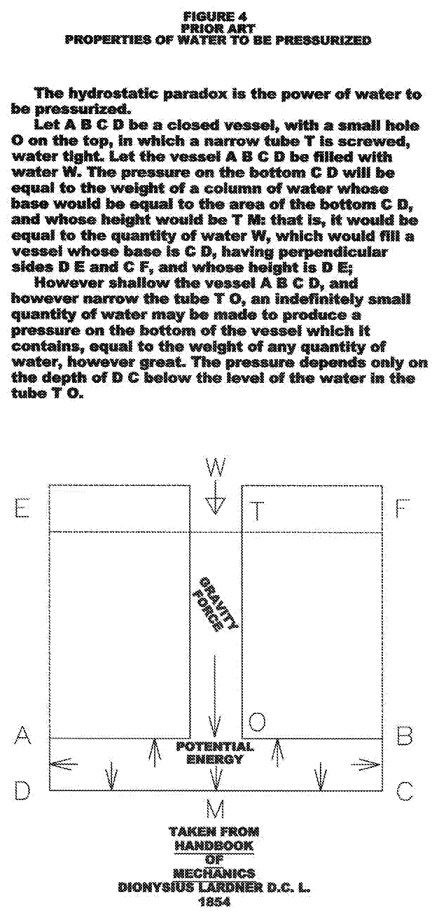

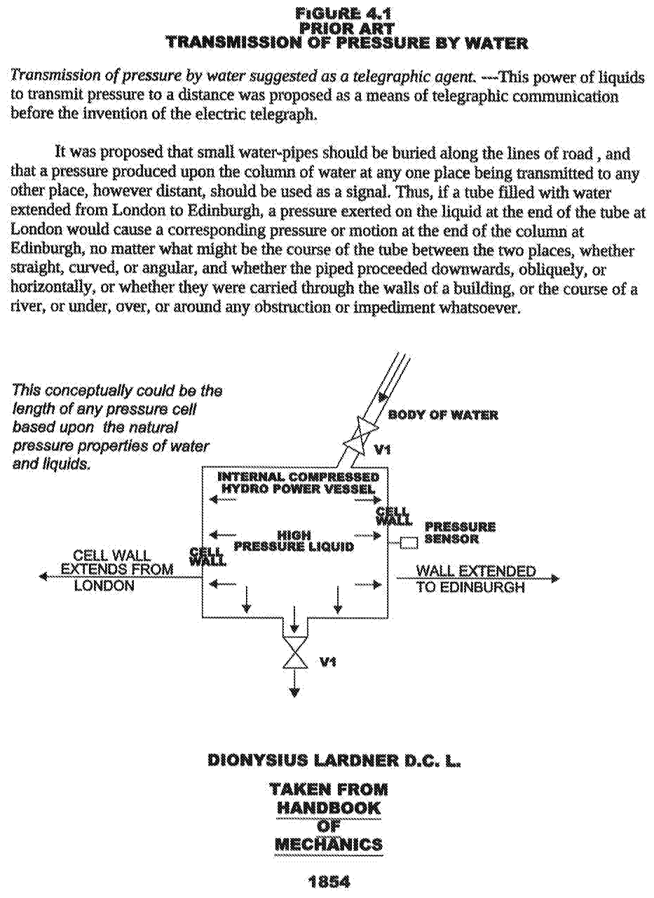

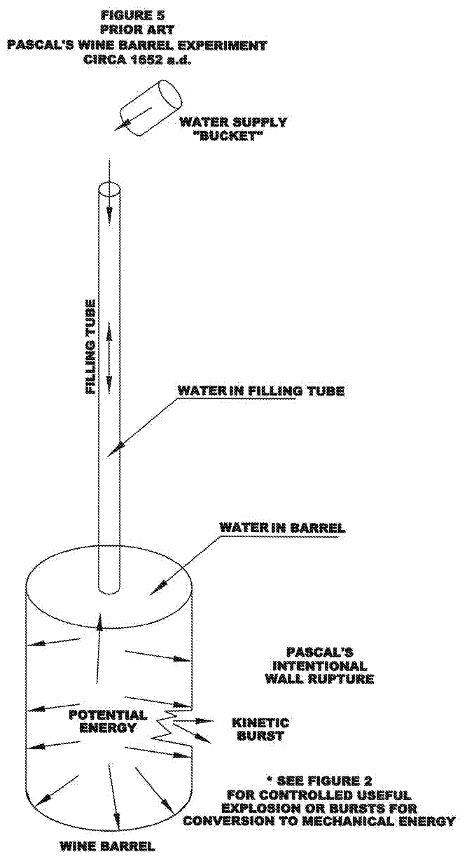

FIG. 2 is a flat plat conceptual representation system top to bottom abbreviated views of the system that has been described in detail by txt and detail previously. The means and methods described are readily understood as to how each part works and relates to the whole. FIG. 3, following, recognizes that the number of cells is only a matter of choice since the variables which ordinarily are constraints are for all practical purpose are simply more about satisfying a desired outcome, the system is very broad and robust.

As context for FIG. 3, FIGS. 1 and 2 have graphically shown by way of methods how the natural laws, FIGS. 4, 4.1a and 5, make it all possible i.e.; (1) the properties of a gas (elasticity & compressibility); (2) the compression (pressurization) of a (non-elastic) liquid in a static state, and (3) the force multiplier effect whereby low pressure compressed air can cause high pressures within a static liquid by operation of a piston acting on the opposing cell's liquid surface contents. Neither force nor static contents are moving as they in that moment are in a shared state of equilibrium. This will prevail as long as the piston's compressed air pressure level (PSI) force is sustained.

FIG. 3 is a flat plat conceptual representation of an array or cluster of closed cells when acting in unison on sequenced command, will expel powerful bursts of kinetic energy. There no practical limits on the number of cells nor their configuration, positional arrangements or volume capacities.
[a] The system has valve V3 as shown by FIGS. 1 & 2 for cells individually filled or in the process of being filled depending upon where they are in the duty cycle;
[b] The energized computer module has sensors that monitor the relative positional state of the several cells as each proceeds through the repeating for non-stroke movement duty cycle;
[c] The computer sends commands for valves V3 in FIGS. 1 & 2 to open or close after the contents of a particular cell are at capacity in a static state, this activates the force multiplier piston into the compression mode;
[d] Following compression to a high PSI level within the cell, a sequenced command is sent to open each discharge valves V5 a, b and c with the contents unloading individually as bursts of energy. The volume of the discharged force is related to the diameter of cell's discharge port and exit pressure (PSI).
[e] The discharge of bursts from cells occurring in succession will approximate a continuous, uniform flow of kinetic energy;
[f] Valve V6 regulates a combined flow output of the system into the mechanical conversion converter for the work component of choice process. After doing its work as a prime mover—the energy-depleted-waste water then exits the system with its properties unchanged and reenters its associated reservoir of water for subsequent recirculation back over and over through the system as a flow of kinetic hydro power.

This Embodiment's Operative Forces are: Gravity-Compressed Air Energy-Potential Hydrostatic Energy-Hydro Kinetic Energy
[a] Quotations from “THE HOW AND WHY WONDER BOOK OF ATOMIC ENERGY” by DONALD BARR, Assistant Dean, School of Engineering, Columbia University, 1961.
   [1] “Energy exists in many forms, and we have learned how to change it from form to form. —We still do not know very clearly what energy is, but we know what it does. It does work. —More simply it is to move things or to change things.—
   [2] In the year 1905, a young German born scientist was working in the Swiss Patent Office, checking other people's inventions. —And he wrote a paper about what he called his Theory of Relativity.”
   [3] “All the physicists had known that energy can be stored in matter and gotten out again too, but they believed that this did not change the amount of matter. —The theory said that when energy is stored in matter, it takes the form of a little additional mass, and when the energy is released, the mass goes back to what it was. —We now have one law, the Law of Conservation of Mass-and-Energy.”—
      [a] In short, this is what it means in respect to the creation of so much extremely high kinetic hydro power pressures from so little compressed air energy input to begin with the system. Energy drawn from the accumulator presses upon the large area of the piston within the pneumatic cylinder.
      [b] The smaller area of the piston presses as an intensified force upon a surface of the liquid (water) contents within the compression chamber. This additional energy results from the amount of water being increased and manifested as such in the form of potential hydrostatic pressure. A weight increase of mass is not measurable but absolutely known to be true.
      [c] The pressurization as described in 1 and 2 is not in any way affected nor influenced by work forces in the external working environment. It is simply a change in energy form, pneumatic to hydraulic. Air to water, the first being elastic & the other being for all practical purposes incompressible. The air to water density ratio is 784 times denser for water at near sea level.
[b] The external air compressor (outside the scope of this embodiment, being an independent supplier of stored energy), must be in communication by fixed conduit with the system's accumulator (compressed air container). In turn, the accumulator is in communication by conduit with the force multiplier (pneumatic piston and cylinder). In turn, the force multiplier is in communication with the compression chamber(s) (internal compressed hydro power vessel), said chamber(s) containing water supplied from the body of water outside the structure. In turn, the compression chamber must be in communication with the flow accumulator (which serves as a common collector of hydro power energy from one or more chambers all being interconnected by conduits and in communication one with the other to serve as a unified provider of hydro power energy to operate the mechanical energy convertor. In turn the flow accumulator is in communication with (as a prime server for a mechanical energy convertor). The convertor (as a work function processor is in communication with an exit port for return downstream of waste water back to the body of water in which the system is immersed for recirculation again/physically unchanged by the system's repetitive processing of such.)

### Preferred Embodiment

This embodiment comprises FOUR independent CHANGE AGENTS for initiating or putting-into-motion masses of fluid matter (gas and water). Other activities are interrelated and cooperating as if one continuing event in unison for the production of hydro power kinetic energy. Some invention (aka Internal Compression Engine) being in all respects a powerful prime mover of hydraulic driven end components. The preferred use would be Hydro-Powered Electricity Generation equivalent to a Hydro Power Dam Generator.
[a] As contrast with my invention, we refer now to the workings of an internal combustion engine found under the hood of a typical gasoline fueled automobile. The engine harnesses natural forces and energy to transform single elements such as fuel, air, spark and pressure into powerful motion for storage/accumulation in a heavy revolving balanced flywheel. Thereafter the energy to be released on demand for work via a drive shaft as rotational torque. The four-cycle events are a choreographed dance where each piece plays an integral role in the system itself while also being driven by it.
[b] My invention is remarkably robust and readily expandable in size/scope plus establishment in multiple arrays, it needs two things to be on hand as part of its work environment site location wherever it might be established:
   [1] A volume of water equivalent to a reservoir or such from which to take/receive a filling inflow of water into its pressure vessel(s) (chambers), to thereafter be pressurized and serve as the medium for transmission of highly pressurized kinetic energy bursts.
   [2] An external air compressor completely independent of but in direct communication as the 24/7 on-demand-supplier of air for the system's compressed air container.
[c] The structure of my invention is graphically illustrated herein by three figures, these being as follow:
   [1] FIG. 2, “INTERNAL COMPRESSION SYSTEM” (ICS)
   [2] “FORCE MULTIPLIER-LOW PRESSURE AIR TO HIGH PRESSURE LIQUID” (FMPAHPL)
   [3] FIG. 3, “DISTRIBUTION OF KINETIC ENERGY-FLOW ACCUMULATOR AND MECHANICAL ENERGY WORK UNIT” (DKEAMEW)
[d] FIGS. 1 and 2 show a conceptual site placement sketch i.e. a contained body of water with free atmosphere. The system is partially submerged within the body of water. The site sketch shows an underwater module attaching surface. Also, the placement of the system compressed air source, an independent supplier's External Air Compressor, is located outside the conceptual module but by conduit being in direct communication with the system's COMPRESSED AIR CONTAINER.
[e] FIGS. 1, 2 and 3 are to be understood as depicting internal functional elements of the system, top to bottom orientation with interrelated features such as connecting conduits, valves, intensifier cylinder & piston, pressure sensor, flow accumulator, air holding tank, annotating descriptions, automated management control module, etc. The drawings provide a coherent blueprint or layout of the system, its makeup and interrelationships. This does not describe the roles played and contributions made which collectively make possible the doing of work, the production of hydro power to put end items into motion to do beneficial work.

The graphic representations disclosed in FIGS. 1, 2 & 3 and FIGS. 4, 4.1 & 5, the natural properties of matter, more specifically attributes of the water molecule, are to be considered and understood fully in all respects. This understanding, though illustrative in nature, does not restrict the implications to be deduced from the means and methods and concepts taught by my invention. These are now discussed in sufficient detail for a person skilled in the art of hydrostatics and fluid dynamics to understand the method and means and intent of my invention. Namely to produce a hydro power flow as a powerful force to do work by the simple application of compressed air energy via an intensifier (piston) to pressurize water, otherwise residing in a state of rest by applying pressure to its molecular mass. This way bypasses/avoids any involvement of/by ordinary workplace factors in the doing of work. Additionally, there are process activities, not Change Agents such as Gravity, Force Multiplier, and Pressure (PSI) level Differences (hydrostatic vs. kinetic states). Details follow:
[a] Compressed Air Energy Element: FIGS. 1 and 2, the COMPRESSED AIR CONTAINER (CAC) receives, contains, and maintains a volume of compressed air energy at all times at predetermined pressure levels as needed/required to support the FORCE MULTIPLIER (FM) element (intensifier assembly) which is comprised of a cylinder, its sliding solid piston and integral chamber, such as are common to all cylinders, pneumatic or hydraulic. The CAC is in direct communication by conduit with the system's independent External Air Compressor (EAC). Valve V2 a solenoid, controlled by automated command, opens and permits/maintains a one-way flow of air into the CAC in sufficient volume and at a programmed pressure level. Valve V2 opens and closes in response to demands for compressed air as the intensifier process proceeds thru its continuing repetitive cycle routine. CAC is in direct communication by conduit with the FORCE MULTIPLIER (FM) element (intensifier). Valve V3, also solenoid controlled by automated command being ready to open and close to permit a one-way flow into FM's cylinder chamber with its sliding piston. This input activity is always premised upon the INTERNAL COMPRESSED HYDRO POWER VESSEL (ICHPV) being filled to full volume capacity and the water is standing at rest in a compression chamber, the next one up in the system's sequence order Air Energy Element routine.
   [1] The Compressed is the cause/means whereby a specific pressure level (PSI), in its elastic state, is directly conveyed/transferred by mechanical device to the water mass resting in a compression chamber. The transferred pressure level (PSI) then is present throughout the entire water-mass-volume This is a creation of energy.
[b] The Gravity Force Element: A CHANGE AGENT, being the cause/means for water intake from the surrounding reservoir of water whenever less than full capacity of pressure cell/chamber occurs, assures the chamber is at full capacity and the mass is at rest in a static state. FIGS. 1 and 2, Valve V1, A one-way no return check valve that is an integral part of the INTERNAL COMPRESSED HYDRO POWER VESSEL (ICHPV), opens and closes subject to the force of Gravity whenever any vacant space (less than full) occurs in the compression chamber i.e. the ICHPPV, the weight of water at depth presses against Valve V2 and forces it to an open position, whereby water is sucked into and replenishes a compression chamber to full capacity. This is an almost instantaneous reaction and it occurs every time that the water in ICHPV's chamber is pressurized by the FM (intensifier) and thereafter Valve V5, a solenoid in response to an automated command opens and discharge of contents is almost instantaneous. This creates space in the chamber and replenishment via Valve V1 is an almost instantaneous reaction. In short Gravity keeps the system going, it moves water, the medium for transmitting energy through this invention, it is the Change Agent for moving things or changing things.
[c] The Force Multiplier (FM): A CHANGE AGENT being the cause/means for compressing of water molecules otherwise being at rest and unable to spontaneous move themselves. The intensifier is in the strictest sense a lever which applies force against the water molecules, the molecules react by small volume increases. The leveraging act itself requires little low pressure compressed air to produce high pressure levels for two reasons. The piston barely moves in its cylinder as the small end of piston rests almost up against the surface of the water in the chamber. The leveraging action is isolated from all resisting factors in the outside work environment in contrast to kinetic movements of things and mass.
   [1] As described [a] above in CAC is in direct communication by conduit from CAC and extends into the intensifier's large cylinder body this is AREA A space above and downward, touching the surface of large area piston end. The solid piston has an extended small shaft body terminating as small area surface. The dimensional area of large piston end divided by comparable area of small piston end is the force multiplication ratio. This intensified (focused i.e. ratio) force that my invention can bring to bear (adding energy) on the surface of the water (or any like liquid) otherwise being at rest (static) within the ICHPV's compression chamber. If a compressed air pressure of 10 PSI was released by Valve V3, as stated paragraph [0007] (A2), and the focused force ratio were 16 to 1, then the force bearing on the molecules in the ICHPV's compression chamber the force would be 160 PSI. Further if the volume (cubic inches) in the chamber was one cubic foot (1,728) then the potential hydrostatic energy would be 276,480 pounds. How much of a single pressurized water mass of any (PSI) magnitude and volume could be released as useful flow by a split-second kinetic burst and repeated immediately by other bursts so to sustain a uniform flow, this is a system design issue.
[d] Pressure (PSI) Level Differences (molecular mass energy increase): A CHANGE AGENT, what this means is that this engine requires minimal quantity of stored energy (compressed air) to create an almost unlimited amount of potential hydrostatic energy within a mass of water resting in a static state. Ready for immediate release as repeating powerful (PSI) bursts of energy in motion against work objects, operating at lesser PSI levels, to do work. Particularly so as an overall input/output result when the released water (liquid) is 784 times denser than air near sea level. Especially so as FIGS. 4 and 4.1 illustrate the physical/mechanical attributes for being pressurized and the communicating of hydro power.
[e] Inertia, a natural CHANGE AGENT just like Gravity, it follows that the masses of water, as ejected from chambers (vessels 1,2 and 3 shown as by FIG. 3), as interval time releases by automated burst pressure Valves 5a,b and c, comprising therefore a sequential, combining, merging flow, have one thing in common as one powerful hydro stream, INERTIA. The inability to stop of their own accord. A primary mover, to do work. A MECHANICAL ENERGY CONVERTER.
(f) Having spent much of its energy in doing work, the flow returns to the body of water from whence it came. Ultimately to be returned by the GRAVITY FORCE ELEMENT at Valve V1 to occupy space as part of the mass at rest in a chamber.

Having described certain embodiments of the invention, it will be apparent to those of ordinary skill in the art that other embodiments incorporating the concepts disclosed herein may be used without departing from the spirit and scope of the invention.

To conclude, this invention uses the natural force of gravity to fill chambers with water and pressurizes it to create molecular energy, and releases it as kinetic Hydro-Power to do work. The described embodiments are to be considered in all respects as only illustrative and not restrictive.

1-7. (canceled)

8. A system comprising an internal Hydrostatic Compression Engine, being partially submerged, immersed in a body of water, its structure attached to an underwater surface, consisting of multiple chambers which are continuously filled by the force of Gravity with water taken in from its outside immersed within environment to fill up each chamber to maximum capacity, and await at rest (static) for its cyclic turn to be pressurized to thousands of pounds of pressure per square inch (PSI), the Force for compression being Compressed Air supplied by others, applied as (energy) by mechanical means (piston) impressed upon water molecules (mass) resting in a static state while confined in a chamber, its repetive potential hydrostatic energy (instantaneous pressure) occurring without any involvement of/by workplace resisting/opposing environmental factors available for immediate high (PSI) energy flow releases of hydro-power, the power function comprising a repeating 4-event duty cycle—intake of water into chambers—increasing (PSI) hydrostatic potential of the molecular mass—expelling powerful hydro bursts of energy for doing work as a prime mover—reloading of replacement water back into for refilling of chambers to full water capacity, and simultaneously resetting of the energy intensifying mechanical compressor piston for the sequenced, repeating next duty cycle repetition, ready as a unified hydro power flow and conversion to mechanical or other energy forms then to be discharged/returned to the body for recirculation over and over again;

9. The system in claim 8 whereas, it is an operating system of interacting pneumatic/hydraulic components and associated high pressure cells, connecting lines, valves and associated parts which are subject to pressures increases/changes, the design and fabrication of its integral components must be in conformance with best practices of the art as established by the Design Institute of Emergency Relief Systems to deal with potential process upsets which might adversely affect system functions and safety of operation;

10. The system in claim 8 is a means for elevating the pressure levels of container contents to hundreds of atmospheres by means of force multiplication of small force (low pressure) to larger force (high pressure) between pneumatic/hydraulic components by means of solid piston transfer agents having opposite area piston size differences, said contents within the array of pressure cells being ready for discharge as bursts of kinetic energy, and flow into/through the associated kinetic energy accumulator distribution system;

11. The system in claim 8 as a means whereby bursts of kinetic energy are expelled from the kinetic energy cell for application as a force acting against workloads not a part of this invention;

12. In the system of claim 8, having an almost unlimited range of design options/choices for creating/manipulating of potential hydrostatic energy levels (PSI) regarding the several critical variables (location, water supply, pressure level ratios), cylinders, pressure cells, etc.), there are no practical limits on scope, scale and purpose for applications of the system, from extremely small individual use to industrial scale applications;

13. In the system of claim 8, wherein a group of hydrostatic/hydraulic engines, structures partially submerged or not within impounded or moving waters, working in collective communication/purpose, one to the other, can create an almost unlimited amount of molecular energy, hydrostatic head, all entities acting together as one in consort can by controlled release of such molecular energy provide enough hydro-power to drive industrial level hydropower plants, the mass medium of water for the entire process, can be recirculating or free flow, in any case being unchanged in physical/chemical properties;

14. In the system of claim 13, wherein an internal compression engine can be established/operated wherever an adequate water source exists a a reservoir, freely moving waters or otherwise, without any change of physical properties/chemical properties;

15. In the system of claim 13, wherein an internal compression engine can be operated wherever an adequate supplier of compressed air available, being in direct communication with the system, provide an on demand pressurized air supply as required;
